(19) United States
(12) Patent Application Publication
(10) Pub. No.: US 2026/0087685 A1
(43) Pub. Date: Mar. 26, 2026

(54) DATA PROCESSING METHOD, DEVICE AND MEDIUM

(71) Applicant: Beijing Zitiao Network Technology Co., Ltd., Beijing (CN)

(72) Inventor: Xiang ZHANG, Beijing (CN)

(21) Appl. No.: 19/333,920

(22) Filed: Sep. 19, 2025

(30) Foreign Application Priority Data
Sep. 26, 2024 (CN) 202411355424.X

(51) Int. Cl. G06T 11/00; G06T 1/20; G06T 1/60; H04L 65/1069; H04L 65/1089; H04L 65/65

(52) U.S. Cl. CPC G06T 11/00; G06T 1/20; G06T 1/60; H04L 65/1069; H04L 65/1089; H04L 65/65; G06T 2200/24

(57) ABSTRACT

Embodiments of the present disclosure provide a data processing method, a device, and a medium. The method includes: in response to a data acquisition event sent by a first effect rendering instance, acquiring and caching available rendering data corresponding to the data acquisition event; in response to an effect rendering event, verifying the available rendering data according to a reusable rendering attribute, so as to perform effect processing on the available rendering data based on the first effect rendering instance when a verification result meets a preset condition; and fusing an effect rendering result with a multimedia data stream pushed to a target client to obtain a target video stream displayed on the target client, in which the target client is a client corresponding to the first object, and the multimedia data stream is a multimedia data stream collected by a client corresponding to the second object.

### CROSS-REFERENCE TO RELATED APPLICATION

This application claims priority to Chinese Patent Application No. 202411355424.X filed on Sep. 26, 2024, the disclosure of which is incorporated herein by reference in its entirety as part of this application.

### TECHNICAL FIELD

Embodiments of the present disclosure relate to the technical field of computer processing, and particularly relate to a data processing method and apparatus, a device, a medium and a product.

### BACKGROUND

Nowadays, in order to improve the watching effect of live streaming and enhance the interactivity of live streaming, it is usually needed to perform effect rendering on various information such as the live streaming content in the live streaming process and the interaction information between users watching the live streaming and a live streamer, and display live streaming images subjected to effect rendering to the users watching the live streaming.

There are usually at least two types of live streaming rendering objects, one is the virtual prop added by the live streamer for the live streaming image, and the other is the virtual object sent to the live streamer by the user watching the live streaming, and the rendering mode of these live streaming rendering objects is usually to synchronously render all the live streaming rendering objects in the live streaming process by a streamer client, and push the entire rendering result to an audience end as an overall video stream. In this effect rendering method, when performing effect rendering on complex scenarios or high-concurrency live streaming rendered objects, there is a problem that the rendering computation is large, resulting in low rendering efficiency.

### SUMMARY

The present disclosure provides a data processing method and apparatus, a device, a medium and a product, to achieve the effects of reducing the rendering computation and improving the effect rendering efficiency.

In the first aspect, the embodiments of the present disclosure provide a data processing method, the method includes:
in response to a data acquisition event sent by a first effect rendering instance, acquiring and caching available rendering data corresponding to the data acquisition event, wherein the first effect rendering instance is an instance for performing effect rendering on a trigger operation of a first object, the available rendering data is rendering process data generated when a second effect rendering instance performs effect rendering, and the second effect rendering instance is an instance for performing effect rendering on a trigger operation of a second object;
in response to the effect rendering event, verifying the available rendering data according to a reusable rendering attribute, so as to perform effect processing on the available rendering data based on the first effect rendering instance when a verification result meets a preset condition; and
fusing an effect rendering result with a multimedia data stream pushed to a target client to obtain a target video stream displayed on the target client, wherein the target client is a client corresponding to the first object, and the multimedia data stream is a multimedia data stream collected by a client corresponding to the second object.

In the second aspect, the embodiments of the present disclosure provide a data processing apparatus, the apparatus includes:
an available rendering data acquisition module, configured to, in response to a data acquisition event sent by a first effect rendering instance, acquire and cache available rendering data corresponding to the data acquisition event, in which the first effect rendering instance is an instance for performing effect rendering on a trigger operation of a first object, the available rendering data is rendering process data generated when a second effect rendering instance performs effect rendering, and the second effect rendering instance is an instance for performing effect rendering on a trigger operation of a second object;
an effect processing module, configured to, in response to the effect rendering event, verify the available rendering data according to a reusable rendering attribute, so as to perform effect processing on the available rendering data based on the first effect rendering instance when a verification result meets a preset condition; and
a target video stream determination module, configured to fuse an effect rendering result with a multimedia data stream pushed to a target client to obtain a target video stream displayed on the target client, in which the target client is a client corresponding to the first object, and the multimedia data stream is a multimedia data stream collected by a client corresponding to the second object.

In the third aspect, the embodiments of the present disclosure provide an electronic device, the electronic device includes:
one or more processors; and
a storage apparatus, configured to store one or more programs,
when the one or more programs are executed by the one or more processors, the one or more processes implement the data processing method according to any one of the embodiments of the present disclosure.

In the fourth aspect, the embodiments of the present disclosure provide a storage medium including computer-executable instructions, the computer-executable instructions, when executed by a computer processor, implement the data processing method according to any one of the embodiments of the present disclosure.

In the fifth aspect, the embodiments of the present disclosure provide a computer program product including a computer program, the computer program is executed by a processor to implement the data processing method according to any one of the embodiments of the present disclosure.

### BRIEF DESCRIPTION OF DRAWINGS

The above and other features, advantages, and aspects of each embodiment of the present disclosure will become more apparent in combination with the accompanying drawings and referring to the specific implementation methods below. Throughout the drawings, the same or similar reference numerals indicate the same or similar elements. It should be understood that the attached drawings are illustrative, and the components and elements may not be drawn to scale.

FIG. 1 is a flow schematic diagram of a data processing method provided by embodiments of the present disclosure;

FIG. 2 is a schematic diagram of a data processing method provided by embodiments of the present disclosure;

FIG. 3 is a sequence diagram of a data processing method provided by embodiments of the present disclosure;

FIG. 4 is a schematic diagram of a data processing method provided by embodiments of the present disclosure;

FIG. 5 is a schematic diagram of a data processing method provided by embodiments of the present disclosure;

FIG. 6 is a schematic diagram of a data processing method provided by embodiments of the present disclosure;

FIG. 7 is a flow schematic diagram of a data processing method provided by embodiments of the present disclosure;

FIG. 8 is a structural schematic diagram of an environment image generation apparatus provided by embodiments of the present disclosure; and

FIG. 9 is a schematic structural diagram of an electronic device provided by embodiments of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” and variants thereof used herein indicate open inclusion, that is, “include but are not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an alternative but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above-mentioned process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

Before introducing the technical solution, an exemplary illustration of the application scenario is provided first. This technical solution can be applied to live streaming scenes that require special effect rendering of the live streaming image in the live streaming process. For example, in a live streaming scene, when a user is watching the live streaming of a live streamer, it is needed to render a series of rendering objects during the live streaming process to push the rendered live streaming image to the user. In this case, effect rendering can be performed based on the technical solution provided by the embodiments of the present disclosure.

In order to more clearly introduce the technical solution, a user watching the live streaming is treated as a first object, and a live streamer is treated as a second object. Then, the implementation process of the technical solution is described with a specific example. Exemplarily, a first effect rendering instance and a second effect rendering instance can be created in advance. In a live streaming process of the second object, the second object can add props for his/her live streaming room, for example, the props can be beauty effect, background, filter effect, map and the like, and it is needed to perform effect rendering on the added props in this case; and the operation of rendering effect can be implemented based on the second effect rendering instance. Moreover, a client of the second object can collect a video stream of live streaming of the second object in real time as a multimedia data stream, and push the multimedia data stream to the client of the first object, and the multimedia data stream is not added with an effect at the moment. The first object can send/give a virtual object to the second object, for example, the virtual object may be a virtual flower, lollipop, ship, automobile, accessory or the like, it is needed to render the virtual object into the multimedia data stream of the client of the first object in this case, and the operation of rendering the effect can be implemented based on the first effect rendering instance. It should be noted that the operation of rendering the effect can be implemented at the client or a server as long as an implementation subject has the implementation function, and there is no limitation for the specific implementation subject; and the specific effect rendering mode can refer to the introduction in the technical solution provided by embodiments of the present disclosure.

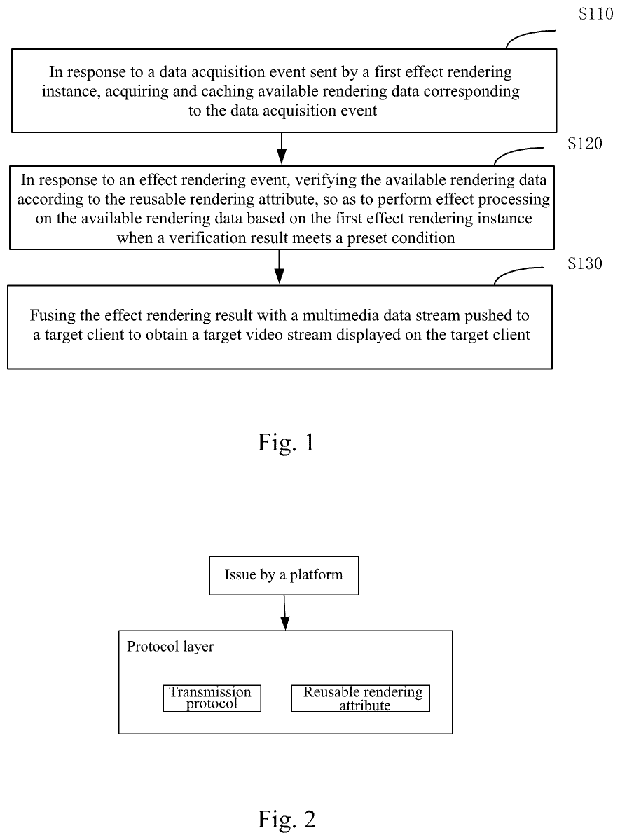

FIG. 1 is a flow schematic diagram of a data processing method provided by embodiments of the present disclosure. The embodiments of the present disclosure are suitable for scenarios needing effect rendering on live streaming images in a live streaming process. This method can be performed by a data processing apparatus, and the apparatus can be implemented in a form of software and/or hardware, optionally, an electronic device; and the electronic device may be a mobile terminal, a PC terminal, a server or the like.

As shown in FIG. 1, the method in this embodiment can specifically include the following steps.
S110, in response to a data acquisition event sent by a first effect rendering instance, acquiring and caching available rendering data corresponding to the data acquisition event.

The first effect rendering instance is an instance for performing effect rendering on a trigger operation of the first object. The trigger operation of the first object may be triggered in the case that the first object has an interactive operation behavior in living streaming of a live streamer, for example, it is triggered in the case that the first object watches the live streaming of the live streamer, or triggered in the case that the first object gives a virtual object to the live streamer, or triggered in the case that the first object publishes comment information in the live streaming, and the operation form may be one from a group consisting of: browse, click, touch, slide and drag-and-drop. The data acquisition event may be an event that triggers data acquisition, and the data acquisition event is monitored to know the available rendering data to be acquired. The available rendering data is rendering process data generated when the second effect rendering instance performs effect rendering. The rendering process data can be a series of intermediate and final data generated in the whole rendering process, for example, the rendering process data includes but is not limited to detected environmental parameters such as illumination, shadow, reflection and refraction in a live streaming scenario, related information (such as face information, head information, clothing information and accessory information) of a user in a live streaming image, and background information in the live streaming image. The second effect rendering instance is an instance for performing effect rendering on the trigger operation of the second object. The second object may be a user in the live streaming image or a user of a live streaming account. The trigger operation of the second object can be triggered in the case that the live streamer has an interactive operation behavior in live streaming, for example, the trigger operation is triggered in the case that the live streamer has body actions in live streaming, or triggered in the case that the live streamer adds the prop for the live streaming image. The first effect rendering instance and the second effect rendering instance may both include a series of rendering flows and implementation strategies designed for specific visual effects.

In this embodiment, when the interactive operation behavior of the second object in live streaming is detected, the second effect rendering instance can perform the effect rendering operation on the live streaming image previewed by the live streamer, and a series of rendering process data will be generated in the effect rendering process. When the first object has an interactive operation behavior in the live streaming of the live streamer, the first effect rendering instance can perform the effect rendering operation on a preview live streaming image of the user watching the live streaming, and can determine that the data acquisition event of the first effect rendering instance is monitored at the server when it is monitored that the first effect rendering instance performs the effect rendering, or, when the first effect rendering instance performs the effect rendering, the first effect rendering instance actively transmits the data acquisition event to the server. When the server receives the data acquisition event from the first effect rendering instance, the available rendering data corresponding to the data acquisition event can be acquired from the rendering process data generated during the effect rendering performed by the second effect rendering instance, and the available rendering data is cached, so that the available rendering data can be used in the effect rendering performed by the first effect rendering instance, thereby reducing the rendering overhead.

It should be noted that in order to ensure that the server can respond to the data acquisition event transmitted by the first effect rendering instance accurately in real time and ensure that the server can acquire the available rendering data from the second effect rendering instance, a protocol layer can be deployed at the server, and thus data communication between the first effect rendering instance and the second effect rendering instance is realized through the protocol layer.

On the basis of the above technical solution, the data processing method further includes: configuring a transmission protocol and a reusable rendering attribute in the protocol layer; and establishing communication between the first effect rendering instance and the protocol layer, establishing communication between the second effect rendering instance and the protocol layer, to send the rendering process data generated by the second effect rendering instance to the first effect rendering instance based on the transmission protocol in the protocol layer, and verify the available rendering data received by the first effect rendering instance based on the reusable rendering attribute.

The transmission protocol may be a rule or an agreement used for transmitting data between two or more communication entities. For example, the transmission protocol may be a Transmission Control Protocol (TCP), a User Datagram Protocol (UDP), a Stream Control Transmission Protocol (SCTP), a Real-time Transport Protocol (RTP), or the like. The reusable rendering attribute may be a rule or a strategy used for verifying whether the rendering process data can be reused. For example, the reusable rendering attribute may include but is not limited to colors, fonts, layout, time and the like.

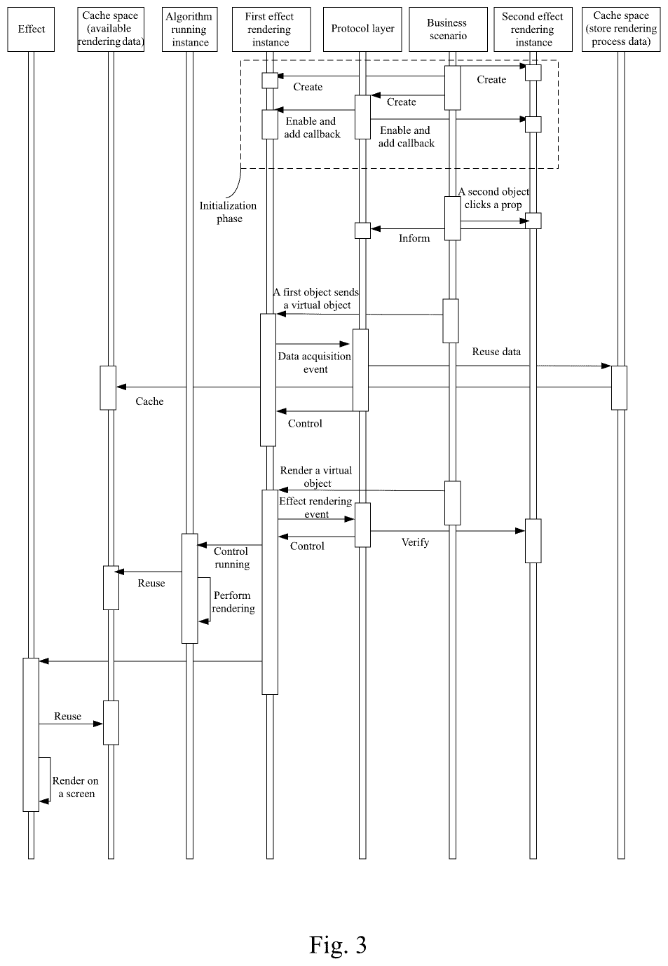

It should be understood that after the transmission protocol is configured in the protocol layer, the communication between the first effect rendering instance and the protocol layer, and the communication between the second effect rendering instance and the protocol layer can be established by using the transmission protocol. Moreover, the reusable rendering attribute can be configured in the protocol layer, therefore, after the available rendering data corresponding to the data acquisition event is acquired, the available rendering data can be verified by using the reusable rendering attribute, and when the verification is passed, the first effect rendering instance can perform effect processing using the available rendering data. Exemplarily, with reference to FIG. 2, the transmission protocol and the reusable rendering attribute can be issued to the protocol layer based on a platform and configured in the protocol layer, thus realizing flexible formulation and issuing of the protocol. Further, with reference to FIG. 3, after the first effect rendering instance, the second effect rendering instance and the protocol layer are created, protocol layer initialization is performed, a callback function is enabled and added in the protocol layer, communication link between the first effect rendering instance and the second effect rendering instance is established, thus the binding between a plurality of instances and the protocol layer is implemented, and a data communication link is opened.

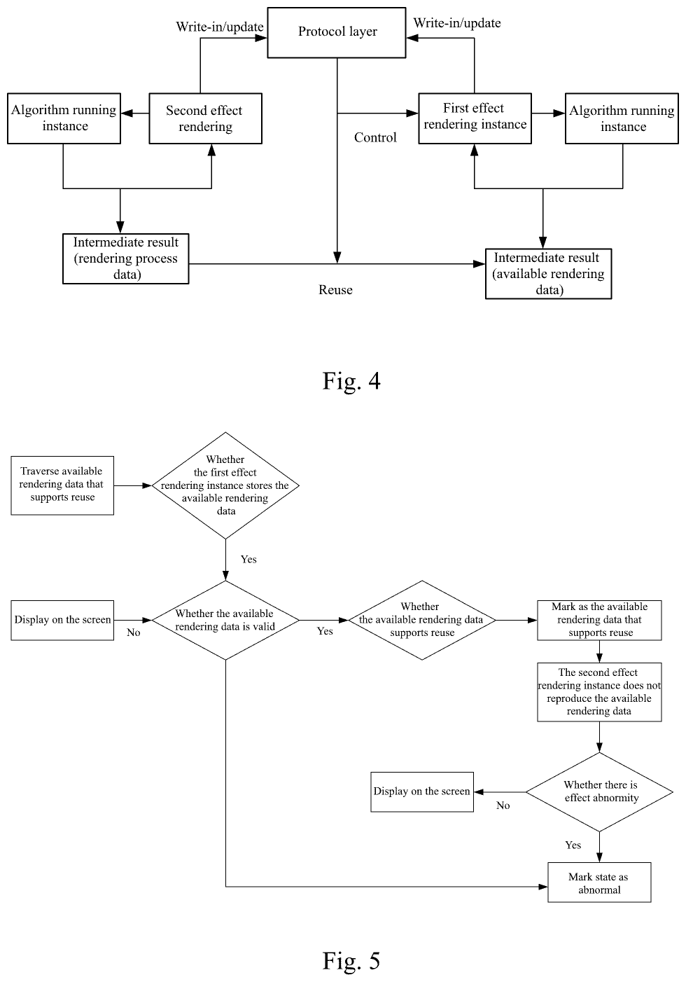

In order to clearly introduce the relationship of the first effect rendering instance, the second effect rendering instance and the protocol layer, referring to FIG. 4, according to the technical solution provided by this embodiment, a new protocol layer is created between the first effect rendering instance and the second effect rendering instance, so that data between the first effect rendering instance and the second effect rendering instance can be transferred through the protocol layer, and the data is also verified and determined by the protocol layer; the protocol layer decides the forms of data consumption, sharing, controlling and the like, which ensures the high efficiency and safety of data transmission as well as the accuracy of effect display.
S120, in response to an effect rendering event, verifying the available rendering data according to the reusable rendering attribute, so as to perform effect processing on the available rendering data based on the first effect rendering instance when a verification result meets a preset condition.

The effect rendering event may be a user-defined event used for triggering the effect rendering.

In this embodiment, the effect rendering event may be configured in advance, for example, when it is monitored that the available rendering data is acquired, or it is detected that the effect rendering instance performs the effect rendering, or an event performed before the effect rendering is performed on the screen, or a specified callback function is called after each live streaming image is rendered, it can be determined that the effect rendering event is monitored. When the effect rendering event is monitored, the pre-configured reusable rendering attribute can be acquired, and the available rendering data is verified by using the reusable rendering attribute, for example, the color of a live streaming scenario in the available rendering data is yellow, the reusable rendering attribute is that the scenario is red, and the two are inconsistent in color, the verification can be considered to be failed, or, the available rendering data is a head position and the reusable rendering attribute is that the head position supports reuse, the verification can be considered to be passed. After the verification result of the available rendering data is obtained, whether the verification result is consistent with a set result (for example, the set result can be that the verification is passed) in the preset condition can be determined, in response to yes, it is considered that the verification result meets the preset condition, and otherwise, the verification result does not meet the preset condition. In the case that the verification result meets the preset condition, the first effect rendering instance is controlled to perform effect processing on the available rendering data.

Exemplarily, with reference to FIG. 3, when the first effect rendering instance renders the virtual object, the effect rendering event is transmitted to the protocol layer, and after the protocol layer receives the effect rendering event, the available rendering data can be verified, so that when the verification is passed, the first effect rendering instance can be controlled to perform the effect processing on the available rendering data.

In order to ensure the synchronization between the image previewed by the live streamer and the image watched in the live streaming, and ensure the display accuracy of the live streaming image, in the process of verifying the available rendering data according to the reusable rendering attribute, for the available rendering data, in response to an event that the available rendering data is valid and the available rendering data supports reuse, it is determined whether the rendering result of the available rendering data is consistent with a preset result; and in response to yes, it is determined that the verification result of the available rendering data is that the verification is passed.

It can be understood that the image in live streaming will dynamically change along with body actions of the live streamer in the live streaming scenario, the actions of participants in the live streaming room or position changes of other things, and when the image at the live streamer end changes, the image at the audience end also changes. In order to ensure the synchronism between the image at the live streamer end and the image at the audience end and avoid the problem of hysteresis of effect display of the image at the audience end, whether the available rendering data is valid can be verified by using the reusable rendering attribute; for example, the reusable rendering attribute can be that one frame of the image is valid, whether the available rendering data is the rendering process data corresponding to the image of the latest frame of the live streamer end is verified by using the reusable rendering attribute, in response to yes, it is verified that the available rendering data is valid, and in response to not, it is verified that the available rendering data is invalid. Moreover, the reusable rendering attribute may also include whether the available rendering data of the second effect rendering instance supports reuse by the first effect rendering instance; therefore, whether the available rendering data supports reuse by the first effect rendering instance can be verified by using the reusable rendering attribute; and in response to yes, it is determined that the event that the available rendering data supports reuse is monitored. Further, in the case that the available rendering data is valid and the event that the available rendering data supports reuse is monitored, an algorithm can be used for detecting whether the effect of the rendering result of the available rendering data is abnormal, in response to not, the rendering result is consistent with the preset result, and in response to yes, the rendering result is inconsistent with the preset result. When the rendering result of the available rendering data is consistent with the preset result, it is determined that the verification result of verifying the available rendering data is that it passes the verification. By verifying the available rendering data and sending the verified available rendering data to the first effect rendering instance for effect rendering, not only the synchronization of the data between an interface of the audience end and the interface of the live streaming end can be guaranteed, but also the effect display effect of the interface of the audience end can be guaranteed, and thus a better live streaming watching experience is provided for the users.

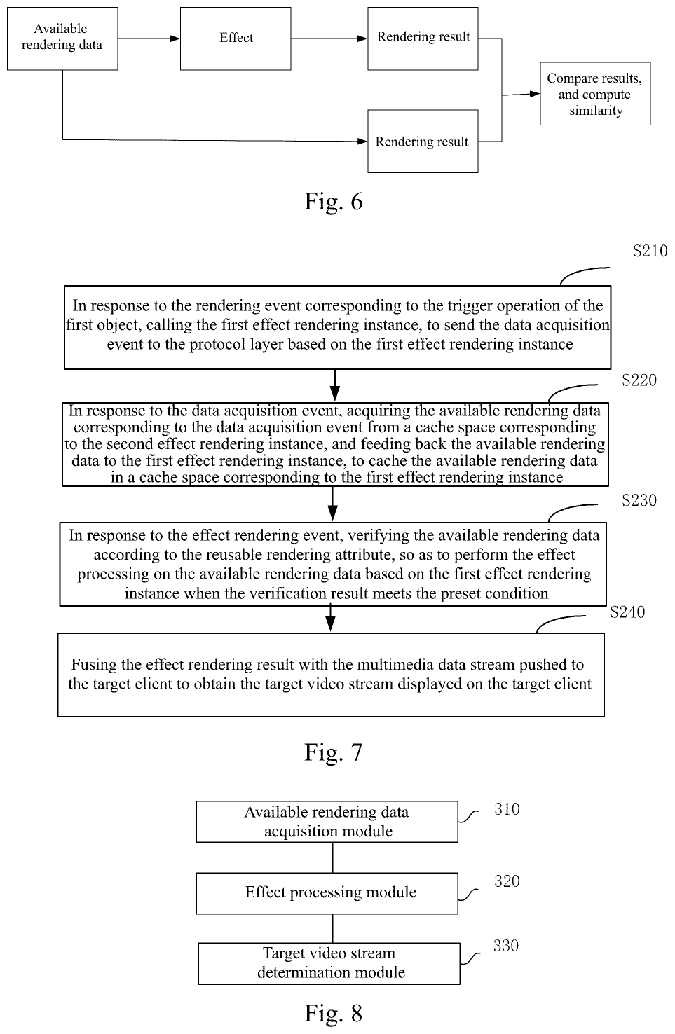

Exemplarily, with reference to FIG. 5, the available rendering data that supports reuse can be traversed to determine whether the first effect rendering instance stores the available rendering data, when the first effect rendering instance stores the available rendering data, whether the available rendering data is valid can be determined; when the available rendering data is valid, whether the available rendering data supports reuse by the first effect rendering instance is determined; and when the available rendering data supports reuse by the first effect rendering instance, the available rendering data is marked as available rendering data that supports reuse. When the second effect rendering instance does not produce the available rendering data any more, whether the rendering result of the available rendering data has an effect abnormity will be verified, in response to yes, the state is marked as abnormity, and in response no, rendering on the screen is performed. For example, with reference to FIG. 6, it is assumed that the user triggers the operation of giving the virtual object, the virtual object can be subjected to effect processing by using the available rendering data to generate a rendering result, the rendering result is compared with the rendering result of the virtual object itself, and the similarity between the two rendering results is computed; in response to the similarity being less than a preset threshold, it is determined that the rendering result of the available rendering data is consistent with the preset result; and in response to the similarity being not smaller than the preset threshold, it is determined that the rendering result of the available rendering data is inconsistent with the preset result.

In this embodiment, the performing the effect processing on the available rendering data based on the first effect rendering instance includes: when the first effect rendering instance performs the effect rendering, reusing the available rendering data to generate an effect rendering result corresponding to the trigger operation of the first object.

Specifically, when the first effect rendering instance performs the effect rendering, it is not needed to repeat to compute the available rendering data; the verified available rendering data can be directly reused by rendering technologies such as a shader and texture, so as to generate the effect rendering result corresponding to the trigger operation of the first object, and the effect rendering result obtained in this case corresponds to the interface of the audience end; and therefore, the rendering computation cost can be reduced, the rendering speed and efficiency can be improved, moreover, the effect rendering result and the multimedia data stream can be ensured to be synchronous in time, thus ensuring the accuracy of effect rendering.

Exemplarily, with reference to FIG. 3, when the first effect rendering instance performs the effect rendering, an algorithm running instance can be controlled to perform a rendering program, and the stored available rendering data is reused. In order to clearly introduce this technical solution, the trigger operation of the first object is introduced by taking the case that the trigger operation is triggered when the first object gives the virtual object to the live streamer as an example, it is assumed that the virtual object is a garland worn on the head, and when the garland is rendered to the head of the live streamer in an effect form, the head information of the live streamer in the available rendering data can be directly used for generating an effect rendering result of the garland worn on the head of the live streamer.
S130, fusing the effect rendering result with a multimedia data stream pushed to a target client to obtain a target video stream displayed on the target client.

The target client is a client corresponding to the first object, namely, the target client is the audience end. The multimedia data stream is the multimedia data stream collected by the client corresponding to the second object. The multimedia data stream can be a data stream formed by at least one media type. For example, the multimedia data stream may be media data containing audio and video images.

In the live streaming scenario, the client corresponding to the second object is the live streamer end, and the multimedia data stream can be the live streaming image, audio information and the like which are simultaneously represented at the streamer end. An original multimedia data stream can be collected from the streamer end, the multimedia data stream obtained at the moment is not added with the effect, and the multimedia data stream can be pushed to the target client. Furthermore, the effect rendering result and the multimedia data stream can be subjected to image fusing by a video processing technology, this process may include operations of image cutting, scaling, rotating, transparency adjusting and the like, and therefore, it is ensured that the effect rendering result can be naturally fused into the live streaming image; and after the target video stream is obtained, the target video stream can be displayed on the target client, the target video stream obtained at the moment includes the fusing effect of the effect rendering result and the live streaming image, and the first object can watch live streaming content with the effect rendering result from the interface of the target client.

In this embodiment, fusing the effect rendering result with the multimedia data stream pushed to the target client to obtain the target video stream displayed on the target client includes: rendering the effect rendering result into the multimedia data stream, and rendering on a screen to obtain the target video stream displayed at the target client.

Specifically, the multimedia data stream pushed to the target client can be analyzed, an image rendering engine can be adopted to render the effect rendering result into the multimedia data stream to generate the effect image, the effect image is displayed on the screen so as to be displayed in the target video stream at the target client; and the effect rendering result and the live streaming content are displayed to the user together, so that the effect display effect is improved.

According to the technical solution of the embodiments of the present disclosure, in response to corresponding to the data acquisition event is acquired and cached, in which the first effect rendering instance is the instance for performing effect rendering on the trigger operation of the first object, the available rendering data is the rendering process data generated when the second effect rendering instance performs effect rendering, and the second effect rendering instance is the instance for performing effect rendering on the trigger operation of the second object; in response to the effect rendering event, the available rendering data according to the reusable rendering attribute is verified, to perform effect processing on the available rendering data based on the first effect rendering instance when the verification result meets the preset condition; and the effect rendering result is fused with the multimedia data stream pushed to the target client so as to obtain the target video stream displayed on the target client, in which the target client is the client corresponding to the first object, and the multimedia data stream is the multimedia data stream collected by the client corresponding to the second object. The problem that in the related technology, the effect rendering on the whole live streaming image is completed at the live streaming end, which causes large rendering computation and low rendering efficiency, is solved; the effect rendering on the trigger operation of the first object is performed by the first effect rendering instance, the effect rendering on the trigger operation of the second object is performed by the second effect rendering instance, and thus the rendering at the live streamer end and the rendering at the audience end are separated; and by separating the rendering tasks, when the first effect rendering instance performs the effect rendering, the rendering process data generated when the second effect rendering instance performs the effect rendering can be acquired, and the available rendering data is verified according to the reusable rendering attribute to realize reuse of part of rendering process data between the two effect rendering instances, so that it is not needed to compute repeatedly the rendering process data during effect rendering, the rendering computation is reduced, and the rendering verification efficiency is improved; and moreover, the verified available rendering data is used in effect processing, thus ensuring the effect display effect of the audience end.

FIG. 7 is a flow schematic diagram of a data processing method provided by embodiments of the present disclosure. The technical solution of this embodiment is on the basis of the above embodiment to further illustrate the features “in response to a data acquisition event transmitted by a first effect rendering instance, acquiring and caching available rendering data corresponding to the data acquisition event”, and the specific implementation mode can refer to detailed description of this embodiment of the present disclosure. The technical features which are the same as or similar to the above embodiment will not be listed here.

As shown in FIG. 7, the method in this embodiment can specifically include the following steps.
S210, in response to the rendering event corresponding to the trigger operation of the first object, calling the first effect rendering instance, to send the data acquisition event to the protocol layer based on the first effect rendering instance.

The rendering event may be an event for triggering a function control of sending/giving the virtual object.

In this embodiment, an event monitor may be provided in advance and configured to monitor events from the interface of the target client, a sensor or other input sources. When the trigger operation (such as click, touch and voice commands) related to the first object is detected, the event monitor captures this trigger event, and when the trigger event is a rendering event, the system calls the first effect rendering instance. After the first effect rendering instance is called, the first effect rendering instance needs to perform effect rendering, and before this, the first effect rendering instance can transmit the data acquisition event to the protocol layer to request to acquire data for effect rendering, namely request to acquire the available rendering data.

Exemplarily, with reference to FIG. 3, taking the first object sending the virtual object to the second object as an example for description. A send control corresponding to the virtual object can be displayed in the interface of the target client; the first object can click the send control or input a shortcut key of the send control by a keyboard to trigger the article sending function corresponding to the control, and the trigger operation can be used for indicating the first effect rendering instance to perform the effect rendering task corresponding to the virtual object, namely, the trigger event corresponding to the trigger operation is the rendering event. That is, when the trigger operation of the first object is detected, the first effect rendering instance can be called, so that the first effect rendering instance can perform the effect rendering task corresponding to the virtual object, and the data acquisition event is transmitted to the protocol layer at the moment.
S220, in response to the data acquisition event, acquiring the available rendering data corresponding to the data acquisition event from a cache space corresponding to the second effect rendering instance, and feeding back the available rendering data to the first effect rendering instance, to cache the available rendering data in a cache space corresponding to the first effect rendering instance.

The data acquisition event includes a rendering data acquisition list corresponding to the trigger operation of the first object, so that after the protocol layer receives the data acquisition event, the available rendering data can be queried through the rendering data acquisition list, which facilitates subsequent efficient effect rendering and displaying. The rendering data acquisition list includes a to-be-acquired rendering identifier corresponding to each rendering data, the cache space corresponding to the second effect rendering instance includes a cache rendering list corresponding to the trigger operation of the second object, and the cache rendering list includes a cache rendering identifier corresponding to each rendering process data. The to-be-acquired rendering identifier can be used for representing the uniqueness of the rendering data, and the rendering data refers to the rendering data to be acquired currently. The cache rendering identifier can be used for representing the uniqueness of the rendering process data, and the rendering process data is result data generated in the rendering process.

In this embodiment, when the first effect rendering instance needs data for effect, or, when the first effect rendering instance starts to perform the effect rendering, a data acquisition event is sent to the protocol layer. When the protocol layer receives the data acquisition event, the rendering data acquisition list corresponding to the trigger operation of the first object in the data acquisition event can be obtained by analyzing. Further, the protocol layer can search the cache rendering identifier matched with the to-be-acquired rendering identifier corresponding to each rendering data in the rendering data acquisition list from the cache space corresponding to the second effect rendering instance, and the rendering process data corresponding to the searched cache rendering identifier is used as the available rendering data. Furthermore, the available rendering data can be fed back to the first effect rendering instance, and the available rendering data is the data required by the first effect rendering instance to perform effect rendering; and in order to avoid the high concurrency problem, the available rendering data can be cached in the cache space corresponding to the first effect rendering instance, thus when the first effect rendering instance performs the effect rendering, the available rendering data can be called at any time from own cache space, which is conducive to reducing the request response time possibly for the same data in the later period, and improving the rendering efficiency.

In this embodiment, in response to the data acquisition event, acquiring the available rendering data corresponding to the data acquisition event from the cache space corresponding to the second effect rendering instance includes: according to the cache rendering identifier corresponding to each rendering process data in the cache rendering list and the to-be-acquired rendering identifier in the rendering data acquisition list, determining to-be-used rendering process data consistent with to-be-acquired rendering identifier; and using the to-be-used rendering process data as the available rendering data.

Specifically, each to-be-acquired rendering identifier in the cache rendering list can be traversed, and for each to-be-acquired rendering identifier, the matched cache rendering identifier can be searched for in the rendering data acquisition list. In response to the matched cache rendering identifier being found, there is the rendering process data in the rendering data acquisition list to meet the current rendering demand of the first effect rendering instance. The rendering process data corresponding to the matched cache rendering identifier can be used as the to-be-used rendering process data consistent with the to-be-acquired rendering identifier. Further, the to-be-used rendering process data can be marked as the available rendering data, so that the available rendering data can be used by the first effect rendering instance in subsequent rendering operation, thus improving the rendering efficiency.
S230, in response to the effect rendering event, verifying the available rendering data according to the reusable rendering attribute, so as to perform the effect processing on the available rendering data based on the first effect rendering instance when the verification result meets the preset condition.
S240, fusing the effect rendering result with the multimedia data stream pushed to the target client to obtain the target video stream displayed on the target client.

According to the technical solution of this embodiment of the present disclosure, when the trigger operation of the first object is detected, the first effect rendering instance is called to send the data acquisition event to the protocol layer based on the first effect rendering instance; and in response to the data acquisition event, the available rendering data corresponding to the data acquisition event is acquired from the cache space corresponding to the second effect rendering instance, and the available rendering data is fed back to the first effect rendering instance, and cached in the cache space corresponding to the first effect rendering instance, so that the first effect rendering instance can acquire the available rendering data from the cache space during effect rendering, thereby improving the data processing efficiency, and improving the rendering efficiency.

FIG. 8 is a structural schematic diagram of a data processing apparatus provided by embodiments of the present disclosure. As shown in FIG. 8, the apparatus includes: an available rendering data acquisition module 310, an effect processing module 320 and a target video stream determination module 330.

The available rendering data acquisition module 310 is configured to: in response to a data acquisition event sent by a first effect rendering instance, acquire and cache available rendering data corresponding to the data acquisition event, in which the first effect rendering instance is an instance for performing effect rendering on a trigger operation of a first object, the available rendering data is rendering process data generated when a second effect rendering instance performs effect rendering, and the second effect rendering instance is an instance for performing effect rendering on a trigger operation of a second object; the effect processing module 320 is configured to: in response to the effect rendering event, verify the available rendering data according to a reusable rendering attribute, so as to perform effect processing on the available rendering data based on the first effect rendering instance when a verification result meets a preset condition; and the target video stream determination module 330 is configured to: fuse an effect rendering result with a multimedia data stream pushed to a target client to obtain a target video stream displayed on the target client, in which the target client is a client corresponding to the first object, and the multimedia data stream is the multimedia data stream collected by a client corresponding to the second object.

On the basis of the above apparatus, optionally, the apparatus further includes:
a configuration module, configured to configure a transmission protocol and the reusable rendering attribute in a protocol layer; and
a communication establishment module, configured to establish communication between the first effect rendering instance and the protocol layer, and establish communication between the second effect rendering instance and the protocol layer, to send the rendering process data generated by the second effect rendering instance to the first effect rendering instance based on the transmission protocol in the protocol layer, and verify the usable rendering data received by the first effect rendering instance based on the reusable rendering attribute.

On the basis of the above apparatus, optionally, the available rendering data acquisition module 310 includes:
an instance calling unit, configured to: in response to the rendering event corresponding to the trigger operation of the first object, call the first effect rendering instance, to send the data acquisition event to the protocol layer based on the first effect rendering instance; and
a data feedback unit, configured to: in response to the data acquisition event, acquire the available rendering data corresponding to the data acquisition event from a cache space corresponding to the second effect rendering instance, and feed back the available rendering data to the first effect rendering instance, to cache the available rendering data in the cache space corresponding to the first effect rendering instance.

On the basis of the above apparatus, optionally, the data acquisition event includes a rendering data acquisition list corresponding to the trigger operation of the first object, the rendering data acquisition list includes a to-be-acquired rendering identifier corresponding to each rendering data, the cache space corresponding to the second effect rendering instance includes a cache rendering list corresponding to the trigger operation of the second object, and the cache rendering list includes a cache rendering identifier corresponding to each rendering process data.

On the basis of the above apparatus, optionally, the data feedback unit includes:
a to-be-rendered process data determination unit, configured to: according to the cache rendering identifier corresponding to each rendering process data in the cache rendering list and the to-be-acquired rendering identifier in the rendering data acquisition list, determine to-be-used rendering process data consistent with to-be-acquired rendering identifier; and
an available rendering data determination unit, configured to use the to-be-used rendering process data as the available rendering data.

On the basis of the above apparatus, optionally, the effect processing module 320 is configured to: for the available rendering data, in response to an event that the available rendering data is valid and the available rendering data supports reuse, determine whether the rendering result of the available rendering data is consistent with a preset result or not; and in response to yes, determine that the verification result of the available rendering data is that the verification is passed.

On the basis of the above apparatus, optionally, the effect processing module 320 is configured to: when the first effect rendering instance performs the effect rendering, reuse the available rendering data to generate an effect rendering result of the determination unit corresponding to the trigger operation of the first object.

On the basis of the above apparatus, optionally, the target video stream determination module 330 is configured to render the effect rendering result into the multimedia data stream, and render on a screen to obtain the target video stream displayed at the target client.

According to the technical solution of the embodiments of the present disclosure, in response to corresponding to the data acquisition event is acquired and cached, in which the first effect rendering instance is the instance for performing effect rendering on the trigger operation of the first object, the available rendering data is the rendering process data generated when the second effect rendering instance performs effect rendering, and the second effect rendering instance is the instance for performing effect rendering on the trigger operation of the second object; in response to the effect rendering event, the available rendering data according to the reusable rendering attribute is verified, to perform effect processing on the available rendering data based on the first effect rendering instance when the verification result meets the preset condition; and the effect rendering result is fused with the multimedia data stream pushed to the target client, to obtain the target video stream displayed on the target client, in which the target client is the client corresponding to the first object, and the multimedia data stream is the multimedia data stream collected by the client corresponding to the second object. The problem that in the related technology, the effect rendering on the whole live streaming image is completed at the live streaming end, which causes large rendering computation and low rendering efficiency, is solved; the effect rendering on the trigger operation of the first object is performed by the first effect rendering instance, the effect rendering on the trigger operation of the second object is performed by the second effect rendering instance, and thus the rendering at the streamer end and the rendering at the audience end are separated; and by separating the rendering tasks, when the first effect rendering instance performs the effect rendering, the rendering process data generated when the second effect rendering instance performs the effect rendering can be acquired, and the available rendering data is verified according to the reusable rendering attribute to realize reuse of part of rendering process data between the two effect rendering instances, so that it is not needed to compute repeatedly the effect rendering process data during effect rendering, the rendering computation is reduced, and the rendering verification efficiency is improved; and moreover, the verified available rendering data is used in effect processing, thus ensuring the effect display effect of the audience end.

The data processing apparatus, such as an environment image generation apparatus provided by the embodiments of the present disclosure can implement the data processing method provided by any embodiment of the present disclosure, and is provided with functional modules corresponding to the implementation of the method and has corresponding beneficial effects.

It is to be noted that each unit and module included in the above-mentioned apparatus are only divided according to the functional logic, but are not limited to the above-mentioned division, as long as the corresponding function can be realized; and in addition, the specific names of respective functional units are only for the convenience of distinguishing them from each other and are not used for limiting the scope of protection of the embodiments of the present disclosure.

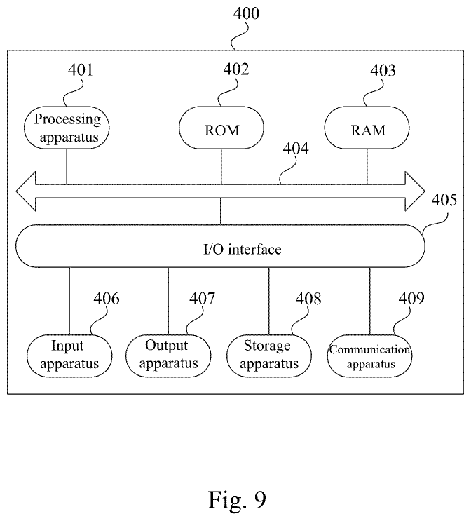

As shown in FIG. 9, an electronic device 400 may include a processing apparatus (such as a central processing unit, and a graphic processing unit) 401, which can perform various appropriate actions and processing according to a program stored in a read-only memory (ROM) 402 or a program loaded from a storage apparatus 408 to a Random Access Memory (RAM) 403. In the RAM 403, various programs and data required for operation of the electronic device 400 are also stored. The processing apparatus 401, ROM 402 and RAM 403 are connected to one another through a bus 404. An input/output (I/O) interface 405 is also connected to the bus 404.

Generally, the following apparatuses can be connected to the I/O interface 405: an input apparatus 406 including, for example, a touch screen, a touch pad, a keyboard, a mouse, a camera, a microphone, an accelerometer, and a gyroscope, an output apparatus 407 including, for example, a Liquid Crystal Display (LCD), a loudspeaker, and a vibrator, a storage apparatus 408 including, for example, a magnetic tape, and a hard disk, and a communication apparatus 409. The communication apparatus 409 can allow the electronic device 400 to perform wireless or wired communication with other electronic devices to exchange data. Although the electronic device 400 with various apparatuses is shown in FIG. 9, it is to be understood that it is not needed to implement or provided with all the shown apparatuses. It can be alternatively implemented or provided with more or less apparatuses.

Particularly, according to the embodiments of the present disclosure, the process described with reference to the flowchart can be implemented as a computer software program. For example, the embodiments of the present disclosure provide a computer program product which includes a computer program carried on a non-transient computer-readable medium, and the computer program contains program codes for executing the method in the flowchart. In such embodiment, the computer program can be downloaded and installed from a network through the communication apparatus 409, or installed from the storage apparatus 408, or installed from the ROM 402. When the computer program is executed by the processing apparatus 401, functions defined in the method according to the embodiments of the present disclosure can be realized.

The names of messages or information exchanged between a plurality of apparatuses in the embodiments of present disclosure are for illustrative purposes only and are not intended to limit the scope of such messages or information.

The electronic device provided by the embodiments of the send embodiment and the data processing method provided by the above embodiments belong to the same invention concept, and the technical details not described in detail in this embodiment can be referred to the above embodiments, and this embodiment has the same beneficial effect as the above embodiments.

The embodiments of the present disclosure provide a computer storage medium, a computer program is stored on the computer storage medium, and when the program is executed by the processor, the data processing method provided by the above embodiments is implemented.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: in response to a data acquisition event sent by a first effect rendering instance, acquire and cache available rendering data corresponding to the data acquisition event, in which the first effect rendering instance is an instance for performing effect rendering on a trigger operation of a first object, the available rendering data is rendering process data generated when a second effect rendering instance performs effect rendering, and the second effect rendering instance is an instance for performing effect rendering on a trigger operation of a second object; in response to the effect rendering event, verify the available rendering data according to a reusable rendering attribute, so as to perform effect processing on the available rendering data based on the first effect rendering instance when a verification result meets a preset condition; and fuse an effect rendering result with a multimedia data stream pushed to a target client to obtain a target video stream displayed on the target client, in which the target client is a client corresponding to the first object, and the multimedia data stream is a multimedia data stream collected by a client corresponding to the second object.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the first acquisition unit may also be described as a unit that acquires at least two Internet Protocol addresses.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A data processing method, comprising:
in response to a data acquisition event sent by a first effect rendering instance, acquiring and caching available rendering data corresponding to the data acquisition event, wherein the first effect rendering instance is an instance for performing effect rendering on a trigger operation of a first object, the available rendering data is rendering process data generated when a second effect rendering instance performs effect rendering, and the second effect rendering instance is an instance for performing effect rendering on a trigger operation of a second object;
in response to an effect rendering event, verifying the available rendering data according to a reusable rendering attribute, so as to perform effect processing on the available rendering data based on the first effect rendering instance when a verification result meets a preset condition; and
fusing an effect rendering result with a multimedia data stream pushed to a target client to obtain a target video stream displayed on the target client, wherein the target client is a client corresponding to the first object, and the multimedia data stream is a multimedia data stream collected by a client corresponding to the second object.

2. The method according to claim 1, further comprising:
configuring a transmission protocol and the reusable rendering attribute in a protocol layer; and
establishing communication between the first effect rendering instance and the protocol layer, and establishing communication between the second effect rendering instance and the protocol layer, to send the rendering process data generated by the second effect rendering instance to the first effect rendering instance based on the transmission protocol in the protocol layer, and verify the available rendering data received by the first effect rendering instance based on the reusable rendering attribute.

3. The method according to claim 2, wherein in response to the data acquisition event sent by the first effect rendering instance, the acquiring and caching available rendering data corresponding to the data acquisition event, comprises:
in response to the rendering event corresponding to the trigger operation of the first object, calling the first effect rendering instance, to send the data acquisition event to the protocol layer based on the first effect rendering instance; and
in response to the data acquisition event, acquiring the available rendering data corresponding to the data acquisition event from a cache space corresponding to the second effect rendering instance, and feeding back the available rendering data to the first effect rendering instance, to cache the available rendering data in a cache space corresponding to the first effect rendering instance.

4. The method according to claim 3, wherein the data acquisition event comprises a rendering data acquisition list corresponding to the trigger operation of the first object, the rendering data acquisition list comprises a to-be-acquired rendering identifier corresponding to each rendering data, the cache space corresponding to the second effect rendering instance comprises a cache rendering list corresponding to the trigger operation of the second object, and the cache rendering list comprises a cache rendering identifier corresponding to each rendering process data.

5. The method according to claim 4, wherein in response to the data acquisition event, the acquiring the available rendering data corresponding to the data acquisition event from the cache space corresponding to the second effect rendering instance, comprises:
according to the cache rendering identifier corresponding to each rendering process data in the cache rendering list and the to-be-acquired rendering identifier in the rendering data acquisition list, determining to-be-used rendering process data consistent with the to-be-acquired rendering identifier; and
using the to-be-used rendering process data as the available rendering data.

6. The method according to claim 1, wherein the verifying the available rendering data according to the reusable rendering attribute, comprises:
for the available rendering data, in response to an event that the available rendering data is valid and the available rendering data supports reuse, determining whether a rendering result of the available rendering data is consistent with a preset result; and
in response to yes, determining that the verification result of the available rendering data is that the verification is passed.

7. The method according to claim 1, wherein the performing effect processing on the available rendering data based on the first effect rendering instance, comprises:
when performing effect rendering based on the first effect rendering instance, reusing the available rendering data to generate an effect rendering result corresponding to the trigger operation of the first object.

8. The method according to claim 1, wherein the fusing an effect rendering result with a multimedia data stream pushed to a target client to obtain a target video stream displayed on the target client, comprises:
rendering the effect rendering result into the multimedia data stream, and rendering on a screen to obtain the target video stream displayed on the target client.

9. An electronic device, comprising:
one or more processors; and
a storage apparatus, configured to store one or more programs,
wherein when the one or more programs are executed by the one or more processors, the one or more processes is caused to:
in response to a data acquisition event sent by a first effect rendering instance, acquire and cache available rendering data corresponding to the data acquisition event, wherein the first effect rendering instance is an instance for performing effect rendering on a trigger operation of a first object, the available rendering data is rendering process data generated when a second effect rendering instance performs effect rendering, and the second effect rendering instance is an instance for performing effect rendering on a trigger operation of a second object;
in response to an effect rendering event, verify the available rendering data according to a reusable rendering attribute, so as to perform effect processing on the available rendering data based on the first effect rendering instance when a verification result meets a preset condition; and
fuse an effect rendering result with a multimedia data stream pushed to a target client to obtain a target video stream displayed on the target client, wherein the target client is a client corresponding to the first object, and the multimedia data stream is a multimedia data stream collected by a client corresponding to the second object.

10. The electronic device according to claim 9, wherein the one or more processes is caused to:
configure a transmission protocol and the reusable rendering attribute in a protocol layer; and
establish communication between the first effect rendering instance and the protocol layer, and establish communication between the second effect rendering instance and the protocol layer, to send the rendering process data generated by the second effect rendering instance to the first effect rendering instance based on the transmission protocol in the protocol layer, and verify the available rendering data received by the first effect rendering instance based on the reusable rendering attribute.

11. The electronic device according to claim 10, wherein the one or more processes is caused to:
in response to the rendering event corresponding to the trigger operation of the first object, call the first effect rendering instance, to send the data acquisition event to the protocol layer based on the first effect rendering instance; and
in response to the data acquisition event, acquire the available rendering data corresponding to the data acquisition event from a cache space corresponding to the second effect rendering instance, and feed back the available rendering data to the first effect rendering instance, to cache the available rendering data in a cache space corresponding to the first effect rendering instance.

12. The electronic device according to claim 11, wherein the data acquisition event comprises a rendering data acquisition list corresponding to the trigger operation of the first object, the rendering data acquisition list comprises a to-be-acquired rendering identifier corresponding to each rendering data, the cache space corresponding to the second effect rendering instance comprises a cache rendering list corresponding to the trigger operation of the second object, and the cache rendering list comprises a cache rendering identifier corresponding to each rendering process data.

13. The electronic device according to claim 12, wherein the one or more processes is caused to:
according to the cache rendering identifier corresponding to each rendering process data in the cache rendering list and the to-be-acquired rendering identifier in the rendering data acquisition list, determine to-be-used rendering process data consistent with the to-be-acquired rendering identifier; and
use the to-be-used rendering process data as the available rendering data.

14. The electronic device according to claim 9, wherein the one or more processes is caused to:
for the available rendering data, in response to an event that the available rendering data is valid and the available rendering data supports reuse, determine whether a rendering result of the available rendering data is consistent with a preset result; and
in response to yes, determine that the verification result of the available rendering data is that the verification is passed.

15. The electronic device according to claim 9, wherein the one or more processes is caused to:
when performing effect rendering based on the first effect rendering instance, reuse the available rendering data to generate an effect rendering result corresponding to the trigger operation of the first object.

16. The electronic device according to claim 9, wherein the one or more processes is caused to:
render the effect rendering result into the multimedia data stream, and render on a screen to obtain the target video stream displayed on the target client.

17. A non-transitory storage medium comprising computer-executable instructions, wherein the computer-executable instructions are executed by a computer processor to:
in response to a data acquisition event sent by a first effect rendering instance, acquire and cache available rendering data corresponding to the data acquisition event, wherein the first effect rendering instance is an instance for performing effect rendering on a trigger operation of a first object, the available rendering data is rendering process data generated when a second effect rendering instance performs effect rendering, and the second effect rendering instance is an instance for performing effect rendering on a trigger operation of a second object;
in response to an effect rendering event, verify the available rendering data according to a reusable rendering attribute, so as to perform effect processing on the available rendering data based on the first effect rendering instance when a verification result meets a preset condition; and
fuse an effect rendering result with a multimedia data stream pushed to a target client to obtain a target video stream displayed on the target client, wherein the target client is a client corresponding to the first object, and the multimedia data stream is a multimedia data stream collected by a client corresponding to the second object.

18. The medium according to claim 17, wherein the computer-executable instructions are executed by a computer processor to:
configure a transmission protocol and the reusable rendering attribute in a protocol layer; and
establish communication between the first effect rendering instance and the protocol layer, and establish communication between the second effect rendering instance and the protocol layer, to send the rendering process data generated by the second effect rendering instance to the first effect rendering instance based on the transmission protocol in the protocol layer, and verify the available rendering data received by the first effect rendering instance based on the reusable rendering attribute.

19. The medium according to claim 18, wherein the computer-executable instructions are executed by a computer processor to:
in response to the rendering event corresponding to the trigger operation of the first object, call the first effect rendering instance, to send the data acquisition event to the protocol layer based on the first effect rendering instance; and
in response to the data acquisition event, acquire the available rendering data corresponding to the data acquisition event from a cache space corresponding to the second effect rendering instance, and feed back the available rendering data to the first effect rendering instance, to cache the available rendering data in a cache space corresponding to the first effect rendering instance.

20. The medium according to claim 19, wherein the data acquisition event comprises a rendering data acquisition list corresponding to the trigger operation of the first object, the rendering data acquisition list comprises a to-be-acquired rendering identifier corresponding to each rendering data, the cache space corresponding to the second effect rendering instance comprises a cache rendering list corresponding to the trigger operation of the second object, and the cache rendering list comprises a cache rendering identifier corresponding to each rendering process data.
